(19) United States
(12) Patent Application Publication
(10) Pub. No.: US 2022/0240714 A1
(43) Pub. Date: Aug. 4, 2022

(54) SENSOR ASSEMBLY

(71) Applicant: Breville Pty Limited, Alexandria, New South Wales (AU)

(72) Inventors: Tae-Kyung KONG, Alexandria (AU); Alex Ming Duk LEUNG, Alexandria (AU); Ali TOFAILI, Alexandria (AU); Con PSAROLOGOS, Alexandria (AU); Stephen John MCCLEAN, Alexandria (AU)

(21) Appl. No.: 17/618,667

(22) PCT Filed: Jun. 23, 2020
(86) PCT No.: PCT/AU2020/050634

§ 371 Date: Dec. 13, 2021

(30) Foreign Application Priority Data
Jun. 28, 2019 (AU) 2019902292

(51) Int. Cl. A47J 31/60; A47J 31/56; A47J 31/46; B08B 3/02

(52) U.S. Cl. CPC A47J 31/60; A47J 31/56; A47J 27/21066; A47J 31/468; B08B 3/02; A47J 31/461

(57) ABSTRACT

An appliance (100, 200) for heating a liquid to make a beverage, the appliance (1) including: a sensor assembly (10) including: a duct (12) having an inlet (18) and an outlet (20), the duct (12) defining a liquid flow path (21) between the inlet (18) and the outlet (20) for the liquid; a sensor (22) having an operative end portion (28) in the flow path (21) for measuring line parameters of the liquid in the flow path (21); and a nozzle (34) to receive water under pressure and direct a water jet transverse to the flow path (21) and towards the operative end portion (28) of the sensor (22) to at least aid in cleaning the operative end portion (28) of the sensor (22).

### FIELD

The present invention relates to sensor assemblies, and in particular but not exclusively, to sensor assemblies employed in appliances used to heat a liquid.

### BACKGROUND

Known appliances used to heat a liquid such as kettles, coffee makers, tea makers etc., heat up water, for example, for use when making beverages. Repeated heating of water, particularly hard water, inside the appliance typically results in the formation of limescale. Disadvantageously, limescale may be deposited on critical parts of sensors (such as negative temperature coefficient “NTC” type thermistors) employed in the appliance thereby impeding proper function and causing undermeasurement. As more water is heated, more limescale is formed which may continue to be deposited on the sensors.

### OBJECT

It is an object of the present invention to substantially overcome, or at least ameliorate, one or more of the above disadvantages.

### SUMMARY OF INVENTION

In a first aspect, the invention provides an appliance for heating a liquid to make a beverage, the appliance including:

a sensor assembly including:
a duct having an inlet and an outlet, the duct defining a liquid flow path between the inlet and the outlet for the liquid;
a sensor having an operative end portion in the flow path for measuring line parameters of the liquid in the flow path; and
a nozzle to receive water under pressure and direct a water jet transverse to the flow path and towards the operative end portion of the sensor to at least aid in cleaning the operative end portion of the sensor.

In a second aspect, the invention provides a method of at least partially removing a limescale deposit on a sensor, the sensor being located in an appliance for heating a liquid to make a beverage, the sensor having an operative end portion in a flow path for the liquid in the appliance, the method including:

providing a nozzle to receive water under pressure so as to produce a water jet; and

orientating the nozzle to direct the water jet transverse to the flow path and towards the operative end portion of the sensor to at least aid in cleaning the operative end portion of the sensor.

In a third aspect, the invention provides a method of manufacturing a sensor assembly for an appliance, the appliance being configured to heat a liquid to make a beverage, the method including:

forming a duct having an inlet and an outlet, the duct defining a liquid flow path between the inlet and the outlet for the liquid;

providing a sensor having an operative end portion for measuring line parameters of the liquid in the flow path;

forming an opening through the duct so as to receive the operative end portion therethrough;

locating the operative end portion through the opening and in the flow path;

forming a nozzle in the duct to receive water under pressure so as to produce a water jet; and

orientating the nozzle to direct the water jet transverse to the flow path and towards the operative end portion of the sensor to at least aid in cleaning the operative end portion of the sensor.

There is also disclosed herein a sensor assembly for an appliance, the appliance being configured to heat a liquid, the assembly including:

a duct having an inlet, an outlet, and a longitudinal sidewall extending between the inlet and the outlet so as to provide a liquid flow path extending between the inlet and the outlet;

a sensor having an operative end portion located in the flow path; and

a nozzle to receive water under pressure so as to produce a water jet, with the nozzle positioned and oriented to direct the water jet transverse to the flow path and at the end portion of the sensor to at least aid in cleaning the end portion.

Preferably, the duct has longitudinally opposite first and second end portions, with the inlet being adjacent the first end portion, with the outlet being adjacent the second end portion, and with the flow path extending linearly between the first and second end portions.

Preferably, the operative end portion of the sensor is located directly opposite the nozzle.

There is further disclosed herein an appliance to heat a liquid, the appliance including:

the above described sensor assembly;

a container to locate the liquid;

a pump fluidly communicable with the container and the inlet to move the liquid from the container to the inlet and along the flow path; and

a heating element mounted adjacent the inlet to heat the liquid moving to the inlet.

In one embodiment, the liquid is water and the appliance further includes a flow-directing assembly in fluid communication with the pump, the inlet and the nozzle, with the flow-directing assembly configured to direct the water from the pump to the inlet in a first flow configuration, and with the flow-directing assembly configured to direct the water to the nozzle in a second flow configuration.

Preferably, the flow-directing assembly includes a flow valve actuatable to a first flow position and a second flow position, with the first flow position corresponding to the first flow configuration, and with the second flow position corresponding to the second flow configuration.

In an alternative embodiment, the liquid is water, the pump is a first pump, and the appliance further includes a second pump fluidly communicable with the container and the nozzle to supply the nozzle with water under pressure.

### BRIEF DESCRIPTION OF DRAWINGS

Exemplary embodiments of the present disclosure will now be described, by way of examples only, with reference to the accompanying description and drawings in which:

FIG. 1 is a schematic perspective view of a sensor assembly according to an embodiment;

FIG. 2 is a schematic front view of the sensor assembly of FIG. 1;

FIG. 3 is a cross-sectional view of the sensor assembly taken along line A-A of FIG. 1;

FIG. 4 is a schematic illustration of a first operating configuration of an appliance employing the sensor assembly of FIG. 1; and

FIG. 5 is a schematic illustration of a second operating configuration of an appliance employing the sensor assembly of FIG. 1.

### DESCRIPTION OF EMBODIMENTS

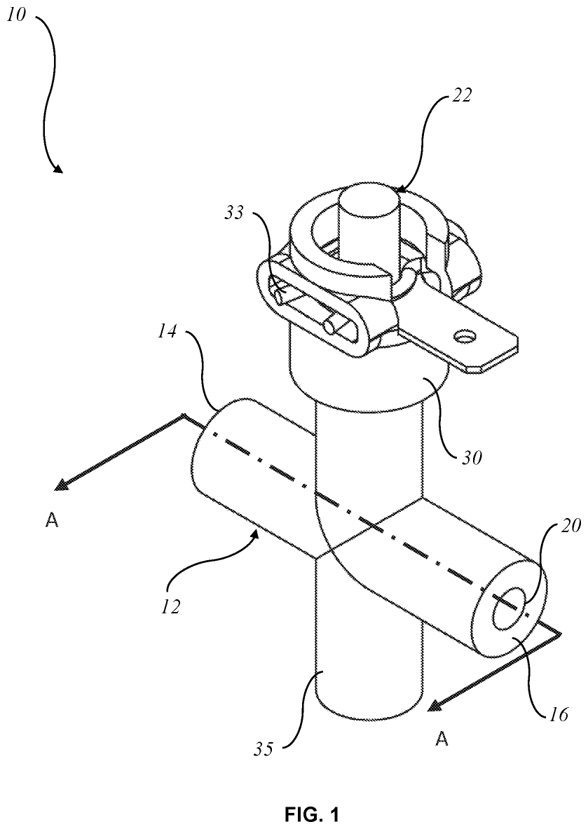

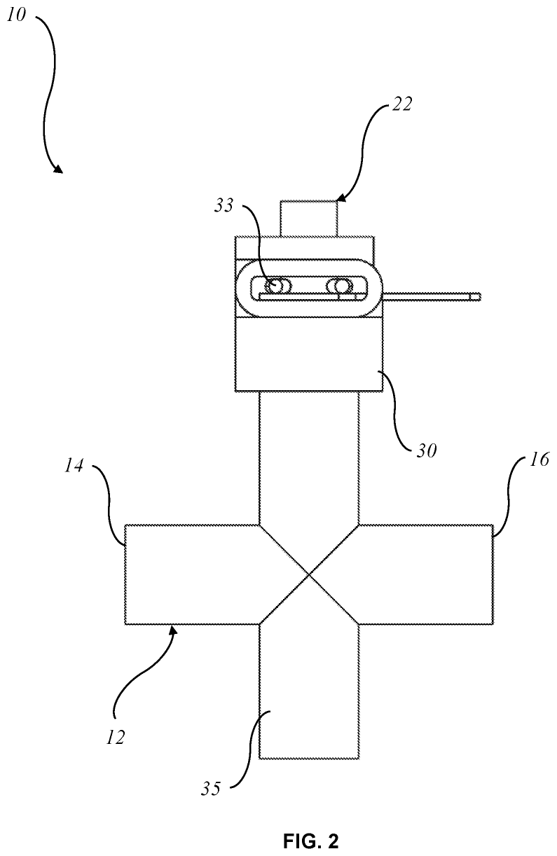

Referring firstly to FIGS. 1 to 3 of the drawings, there is schematically depicted a sensor assembly 10 for an appliance 100, 200. The appliance 100, 200 is configured to heat a liquid, such as water, for making a beverage, such as coffee.

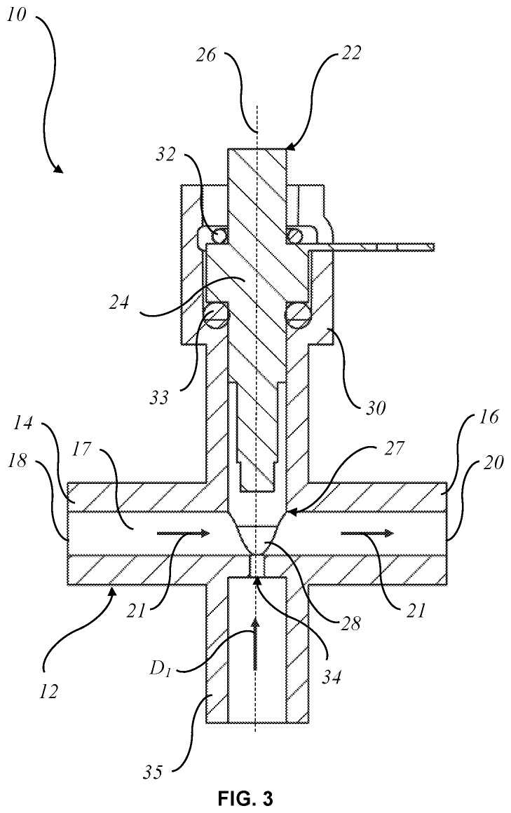

The assembly 10 includes a duct in the form of a tube 12 having longitudinally opposite first and second end portions 14, 16. As shown in FIG. 3, the tube 12 has an inlet 18 located adjacent the first end portion 14, and an outlet 20 located adjacent the second end portion 16. The tube 12 has a longitudinal sidewall 17 extending between the inlet 18 and the outlet 20 so as to provide a liquid flow path 21 extending linearly between the first and second end portions 14, 16.

The assembly 10 also includes a sensor 22 for measuring line parameters (such as temperature, pressure, flow, clarity and the like) of the liquid flowing along the path 21. In the preferred embodiment, the sensor 22 is an NTC type sensor configured to measure a temperature of the liquid.

The sensor 22 has a body 24 providing a longitudinal axis 26 and an operative end portion 28 located at one end of the body 24. The sensor 22 is positioned with respect to the tube 12 so that the axis 26 is generally perpendicular to the flow path 21. The tube 12 provides an opening 27 for the operative end portion 28 to extend therethrough so that the operative end portion 28 is located within the flow path 21. In the preferred embodiment, the sensor 22 is housed within a housing bracket 30 integrally formed with the tube 12. The sensor 22 is secured within the bracket 30 by a retainer clip 32. A seal in the form of an 0-ring 33 sealingly connects the body 24 with the bracket 30.

The assembly 10 also includes a nozzle 34 to receive water under pressure so as to produce a water jet. The nozzle 34 is formed in the sidewall 17. The nozzle 34 is positioned and oriented to direct the water jet transverse to the flow path 21 and at the operative end portion 28 of the sensor 22 to at least aid in cleaning the operative end portion 28.

The nozzle 34 is generally aligned with the axis 26 so that the operative end portion 28 is directly opposite the nozzle 34. In the preferred embodiment, the nozzle 34 is in fluid communication with a pipe 35 integrally formed with the sidewall 17 of the tube 12. The pipe 35 is configured to convey water under pressure to the nozzle 34 in a direction Di parallel with the axis 26. The nozzle 34 preferably has a diameter of about 1 mm. In the preferred embodiment, the nozzle 34 receives water at a temperature in the range of about 20° C. to 40° C. It will be appreciated that the temperature may be selected to sufficiently dissolve limescale. In the preferred embodiment, the water jet has a predetermined velocity and pressure. It will be appreciated that the temperature, velocity and pressure may be varied depending on the amount of limescale deposition on the operative end portion 28.

In one or more embodiments, the assembly 10 includes a waterslug (not shown) operatively associated with the nozzle 34 to permit the water jet to exit the nozzle 34 whilst preventing liquid flowing along the path 21 from entering the nozzle 34.

It will be appreciated that the assembly 10 may operate in a cleaning cycle in which the nozzle 34 produces the water jet to clean the end portion 28. In the preferred embodiment, the assembly 10 includes a processor (not shown) operatively associated with the sensor 22 to monitor temperature signals from the sensor 22. It will be appreciated that the sensor 22 may output one or more signals to the processor indicating a temperature decrease during the cleaning cycle as the water jet cleans the end portion 28. It will also be appreciated that the sensor 22 may output one or more signals to the processor indicating a temperature increase of the liquid flowing along the path 21 to determine whether limescale deposition is occurring. In one or more embodiments, the assembly 10 includes a flowmeter (not shown) operatively associated with the nozzle 34 to monitor working parameters of the water jet.

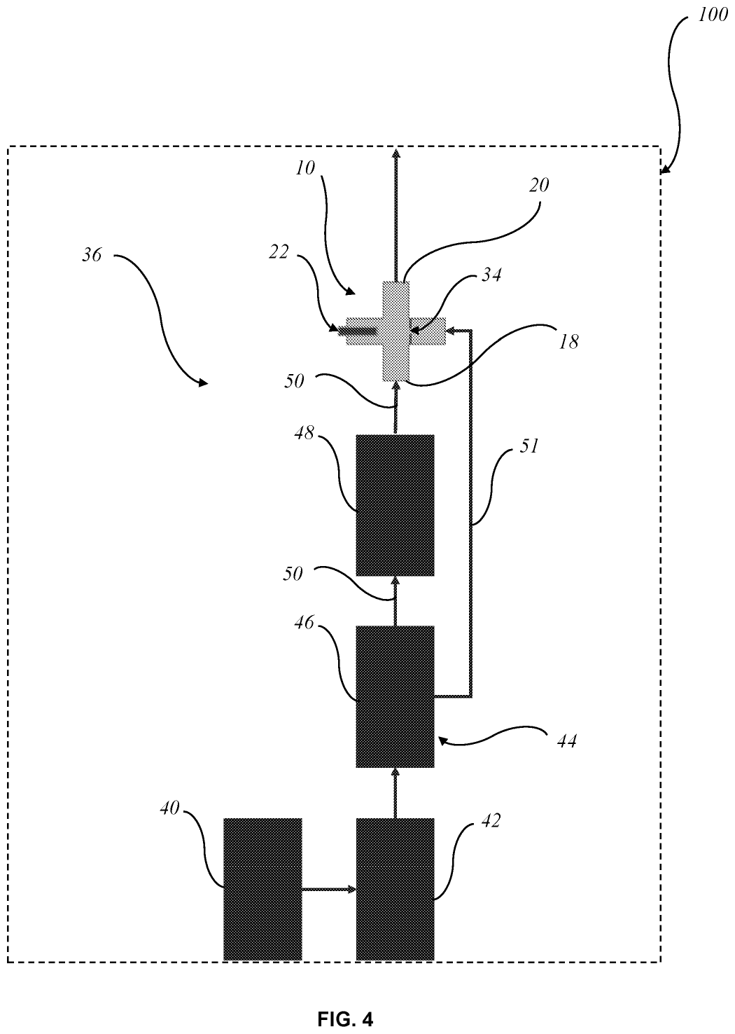

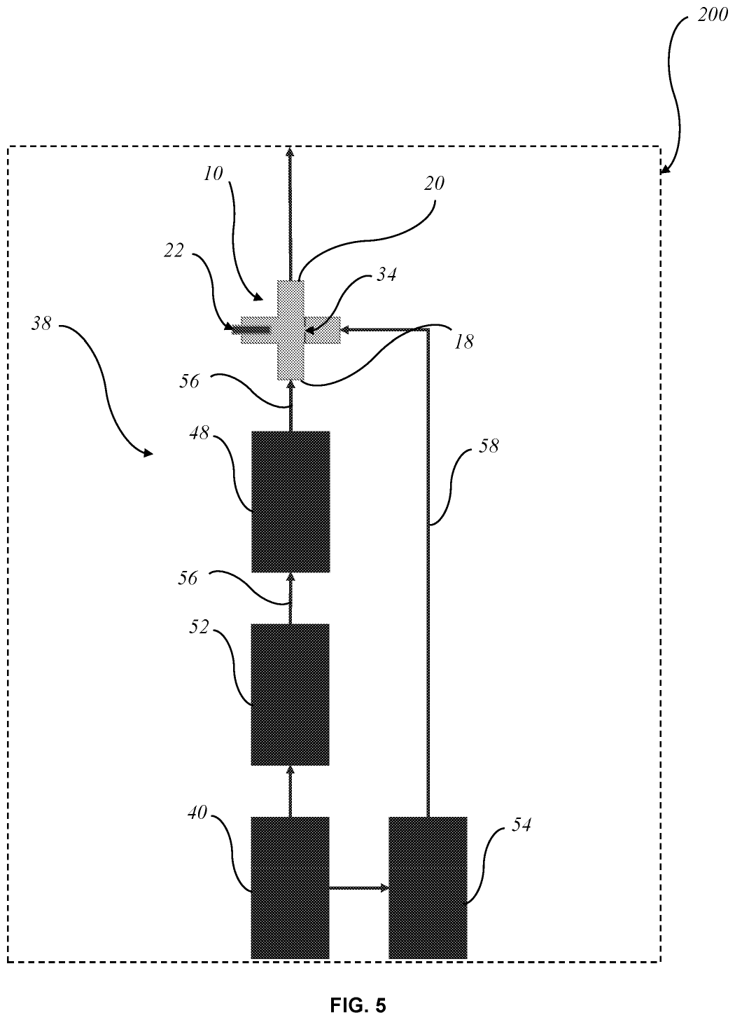

Referring to FIGS. 4 and 5, there is schematically depicted first and second operating configurations 36, 38 of the appliance 100, 200 employing the assembly 10.

In the first operating configuration 36 depicted in FIG. 4, the appliance 100 includes a water tank 40, a pump 42 fluidly communicable with the tank 40, a flow-directing assembly 44 including a flow valve 46, a heater 48, and the assembly 10. The valve 46 is fluidly communicable with the pump 42 and the inlet 18.

The pump 42 moves water stored in the tank 40 to the valve 46.

The valve 46 is actuatable to a first flow position and a second flow position. Actuation of the valve 46 to the first flow position causes the water to flow along a first flow path 50 to the inlet 18 of the assembly 10 in a first flow configuration. The heater 48 is positioned along the path 50 to heat the water to an operating temperature as the water flows along the path 50.

Actuation of the valve 46 to the second flow position causes the water to flow along a second flow path 51 to the nozzle 34 in a second flow configuration. It will be appreciated that the water is not heated by the heater 48 as the water flows along the second flow path 51. It will also be appreciated that, during the cleaning cycle of the appliance 100, the valve 46 is in the second flow position. In one or more embodiments, the valve 46 is a three-way solenoid valve.

In the second operating configuration 38 depicted in FIG. 5, the appliance 200 includes the water tank 40, first and second pumps 52, 54, the heater 48, and the assembly 10. The first pump 52 is fluidly communicable with the tank 40 and the inlet 18. The second pump 54 is fluidly communicable with the tank 40 and the nozzle 34.

The first pump 52 moves water stored in the tank 40 along a primary flow path 56 to the inlet 18 of the assembly 10. The heater 48 is positioned along the path 56 to heat the water to an operating temperature as the water flows along the path 56.

The second pump 54 moves water stored in the tank 40 along a secondary flow path 58 to the nozzle 34 under pressure. It will be appreciated that the primary and secondary flow paths 56, 58 are independent to each other. It will also be appreciated that, during the cleaning cycle of the appliance 200, the second pump 54 is operative whilst the first pump 52 is inoperative.

In one or more embodiments, the pumps 42, 52, 54 may be rotary solenoid pumps or vane pumps.

It will be appreciated that both the configuration of the linear flow path 21 and the nozzle 34 aid in at least minimizing limescale deposition on the operative end portion 28 of the sensor 22.

### REFERENCE LIST

100 Appliance according to an embodiment
200 Appliance according to another embodiment
10 Sensor assembly
12 Tube
14 First end portion
16 Second end portion
17 Longitudinal sidewall
18 Inlet
20 Outlet
21 Liquid flow path
22 Sensor
24 Body
26 Longitudinal axis
27 Opening
28 Operative end portion
30 Mounting bracket
32 Retainer clip
33 O-ring
34 Nozzle
35 Pipe
36 First operating configuration
38 Second operating configuration
40 Water tank
42 Pump
44 Flow-directing assembly
46 Flow valve
48 Heater
50 First flow path
51 Second flow path
52 First pump
54 Second pump
56 Primary flow path
58 Secondary flow path

1. An appliance for heating a liquid to make a beverage, the appliance including:
a sensor assembly including:
a duct having an inlet and an outlet, the duct defining a liquid flow path between the inlet and the outlet for the liquid;
a sensor having an operative end portion in the flow path for measuring line parameters of the liquid in the flow path; and
a nozzle to receive water under pressure and direct a water jet transverse to the flow path and towards the operative end portion of the sensor to at least aid in cleaning the operative end portion of the sensor.

2. The appliance of claim 1, wherein the duct has longitudinally opposite first and second end portions, with the inlet being adjacent the first end portion, with the outlet being adjacent the second end portion, and with the flow path extending linearly between the first and second end portions.

3. The appliance of claim 1 or 2, wherein the operative end portion of the sensor is located directly opposite the nozzle.

4. The appliance of any one of the preceding claims further including:
a container to locate the liquid;
a pump fluidly communicable with the container and the inlet to move the liquid from the container to the inlet and along the flow path; and
a heating element mounted adjacent the inlet to heat the liquid as the liquid moves toward the inlet.

5. The appliance of claim 4, wherein the liquid is water and the appliance further includes a flow-directing assembly in fluid communication with the pump, the inlet and the nozzle, with the flow-directing assembly configured to direct the water from the pump to the inlet in a first flow configuration, and with the flow-directing assembly configured to direct the water to the nozzle in a second flow configuration.

6. The appliance of claim 5, wherein the flow-directing assembly includes a flow valve actuatable to a first flow position and a second flow position, with the first flow position corresponding to the first flow configuration, and with the second flow position corresponding to the second flow configuration.

7. The appliance of claim 4, wherein the liquid is water, the pump is a first pump, and the appliance further includes a second pump fluidly communicable with the container and the nozzle to supply the nozzle with water under pressure.

8. A method of at least partially removing a limescale deposit on a sensor, the sensor being located in an appliance for heating a liquid to make a beverage, the sensor having an operative end portion in a flow path for the liquid in the appliance, the method including:
providing a nozzle to receive water under pressure so as to produce a water jet; and
orientating the nozzle to direct the water jet transverse to the flow path and towards the operative end portion of the sensor to at least aid in cleaning the operative end portion of the sensor.

9. The method of claim 8, wherein providing the nozzle includes providing the nozzle directly opposite the operative end portion of the sensor.

10. A method of manufacturing a sensor assembly for an appliance, the appliance being configured to heat a liquid to make a beverage, the method including:
forming a duct having an inlet and an outlet, the duct defining a liquid flow path between the inlet and the outlet for the liquid;
providing a sensor having an operative end portion for measuring line parameters of the liquid in the flow path;
forming an opening through the duct so as to receive the operative end portion therethrough;
locating the operative end portion through the opening and in the flow path;
forming a nozzle in the duct to receive water under pressure so as to produce a water jet; and
orientating the nozzle to direct the water jet transverse to the flow path and towards the operative end portion of the sensor to at least aid in cleaning the operative end portion of the sensor.

11. The method of claim 10, wherein forming the duct includes forming longitudinally opposite first and second end portions providing the inlet and the outlet, respectively, so that the flow path extends linearly between the inlet and the outlet.

12. The method of claim 11, wherein forming the opening includes forming the opening directly opposite the nozzle so that the operative end portion of the sensor is locatable directly opposite the nozzle.
